(19) United States
(12) Patent Application Publication
(10) Pub. No.: US 2002/0016834 A1
(43) Pub. Date: Feb. 7, 2002

(54) METHOD OF COMMUNICATING DIGITAL DATA AND A SYSTEM FOR IMPLEMENTING THE METHOD

(76) Inventors: JEAN-MARIE VAU, PARIS (FR); GERARD GAUD, NEUILLY PLAISANCE (FR); JEAN-CLAUDE LE BEUX, VINCENNES (FR)

Correspondence Address: THOMAS H. CLOSE, EASTMAN KODAK COMPANY, 343 STATE STREET, ROCHESTER, NY, 14650-2201, US

(21) Appl. No.: 08/836,834

(22) PCT Filed: Nov. 14, 1995
(86) PCT No.: PCT/EP95/04460

(30) Foreign Application Priority Data
Nov. 23, 1994 (FR) 9414310

(51) Int. Cl. G06F 15/173

(52) U.S. Cl. 709/223

(57) ABSTRACT

The invention concerns a digital data communication system.

The system comprises: a first station (1) containing data in digital form; a second station (2) intended to receive the data; a bidirectional link (20) enabling the data to be transferred, the bidirectional link transferring the data, parameters relating to the transferred data and command and control signals generated by the second station (2); a third station (9) intended also to receive said data; and a communication interface (39) for capturing the data passing over the bidirectional link (20) and routing them to the third station (9) and, in response to the command and control signals generated by said second station, for managing the transfer of the data to the third station (9).

### FIELD OF THE INVENTION

The invention concerns the transmission of digital data and in particular concerns the transmission of images such as the ones used in the medical field and generated, for example, by medical imaging equipment such as a scanograph, a magnetic resonance imaging device, a digital angiograph, a digital radiology table or an echograph. These applications are given only for illustrative purposes and in no way constitute a limitation of the present invention.

### BACKGROUND OF THE INVENTION

In the field of medical radiography, it is becoming more and more essential to be able to connect gateways to imaging equipment such as that mentioned above, to enable, for example, images to be transmitted over a network (LAN or WAN).

According to a first approach depicted in FIG. 1, a video image coming from medical imaging equipment 1 is transmitted to a laser reprographic unit by means of a coaxial cable 3. Using a keyboard 4, an operator sends to the laser reprographic unit a control signal in response to which the reprographic unit stores the video signal which is transmitted over the coaxial cable 3. A gateway 5 is connected to the cable 3 by means of a connector 6 and takes off the video signal passing over the line 3. Such a gateway can be activated selectively by means of a computer terminal 7. The terminal 7 also enables an operator to send, to the gateway, data which for example enables the patient with whom the image is associated to be identified. Typically, such a gateway includes a video card of the type shown in FIG. 2.

As depicted in FIG. 2, this card comprises an input 10, intended to receive the video signal. The latter is converted by means of an analogue to digital converter 11 into a digital signal which is then stored in a memory 12, from which it is sent, for example, over an interface 13, to the motherboard of a PC-type computer. These operations are controlled by a central unit 14. The digital files thus stored (in a PC or other equivalent station) can then be manipulated or sent over a network of the ETHERNET or NUMERIS type. The problem with such a solution lies in the fact that the quality of the video images transmitted may prove inadequate for some applications.

More recently, and as depicted in FIG. 3, the manufacturers of imaging equipment (SIEMENS, GENERAL ELECTRIC, PHILIPS, etc) have begun to supply digital connections which transmit image data over a link 20 of the RS 422/485 type using a given protocol, the image transfer being controlled by a link 21 which varies according to the manufacturer of the imaging equipment. Typically, the control signals passing over the line 21 are generated by an operator by means of a keyboard or a screen on which a selection menu appears. With such constraints imposed by the manufacturer of the modality, it is generally complicated to connect a gateway system to a modality. This in fact requires access to different protocols and may be very expensive. Another solution consists of using the video output of the imaging equipment and processing the signal in the manner explained above with reference to FIGS. 1 and 2. Apart from the drawbacks presented above, the video approach is sometimes not possible since no video output is provided on the imaging equipment.

One of the objects of the present invention is therefore to provide a system and a method for transmitting digital information which do not have the drawbacks mentioned above.

Other objects of the present invention will emerge in detail in the following description.

### SUMMARY OF THE INVENTION

According to the present invention, these objects are achieved by means of a digital data communication system comprising:

a) a first station including means for storing data in digital form;

b) a second station intended to receive said data;

c) a bidirectional link allowing transfer of the data from said first station to the second, said bidirectional link providing, in one direction, the transfer of the data and of parameters relating to the data transferred and, in the other direction, the transfer of command and control signals generated by the second station and intended to manage the transfer of said data;

d) a third station intended to receive also said data, and;

e) a communication interface having means intended to capture the data passing over the bidirectional link without affecting the transfer thereof to the second station and to route them to the third station, and means for managing, in response to the command and control signals generated by said second station, the transfer of the data to the third station.

According to the present invention, a communication interface is also produced, comprising

a) means intended to capture the digital data passing over a bidirectional link between a first station and a second, said bidirectional link providing, in one direction, the transfer of the data and of parameters relating to the data transferred and, in the other direction, the transfer of command and control signals generated by the second station and intended to manage the transfer of said data;

b) means for routing the data thus captured to a third station intended also to receive said data; and

c) means for managing, in response to the command and control signals generated by the second station, the transfer of said data to said third station.

Advantageously, the interface according to the invention comprises:

i) connection means for receiving the data and certain control data passing over the bidirectional link;

ii) means for decoding the data thus received, said decoding means being sensitive to said control data, so as to control the storage of the data in appropriate storage means; and

iii) means for selectively controlling, in response to a signal transmitted by the decoding means, the unloading of the data from the storage means to said third station.

The present invention also provides a method for communicating digital data comprising the following steps:

a) storing data in digital form in the memory of a first station;

b) transferring said data from said first station to a second station by means of a bidirectional link, said bidirectional link providing, in one direction, the transfer of the data and of parameters relating to the data transferred and, in the other direction, the transfer of command and control signals generated by the second station and intended to manage the transfer of said data;

c) capturing the data passing over the bidirectional link without affecting the transfer thereof to the second station, and

d) routing the information thus captured to a third station, the transfer of the data to said third station being managed by the command and control signals generated by said second station.

### BRIEF DESCRIPTION OF THE DRAWINGS

In the following detailed description, reference will be made to the drawings in which:

FIG. 1 depicts a first type of conventional link between digital imaging equipment and a laser reprographic unit;

FIG. 2 illustrates in block diagram form a video card traditionally used in the link of FIG. 1;

FIG. 3 depicts diagrammatically a second type of conventional link between digital imaging equipment and a laser reprographic unit;

FIG. 4 depicts a first embodiment of the digital data communication system according to the present invention;

FIG. 5 depicts in block diagram form a preferred embodiment of the communication interface according to the present invention; and

FIGS. 6A-6C depict the shape of certain control signals used in the communication system according to the present invention.

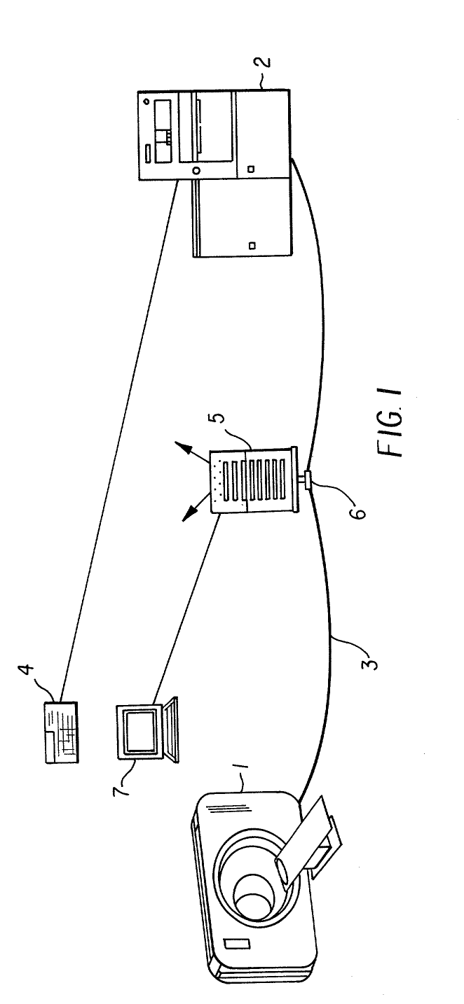

### DETAILED DESCRIPTION OF THE INVENTION

In the following description, reference will be made principally to applications related to the medical field, namely communication between digital imaging equipment and a laser reprographic unit. It is obvious that the present invention is not limited to such applications and in a general way relates to the communication of digital data, whatever their nature or origin. To this end, the invention could also find an application in the communication of digital audio data.

FIG. 4, to which reference is now made, depicts overall the communication system according to the invention. In the embodiment depicted, the image data are generated by a scanograph 1 and stored in memory spaces provided for this purpose. Advantageously, such a scanograph includes a screen (not shown) on which the image recorded by the scanograph is displayed. As will be seen in more detail later, such a screen can be used by an operator for sending, by means of a menu, a control signal intended for the laser reprographic unit 2 over the control line 21. In response to this control signal, the laser reprographic unit transmits a signal instructing the scanograph to send a data packet. Such a control signal can also be generated by means of a keyboard (not shown) at the scanograph. Various links can be used between the digital equipment and the laser reprographic unit. For example, an RS 422/485 link is used, over which pass, in one direction, the digital data coming from the scanograph (station 1) and various parameters relating to the data packets transferred (this will be explained in more detail later) and, in the other direction, control data transmitted by the reprographic unit (station 2) and intended for the scanograph. Likewise, the control line 21 can consist of an RS 422 or RS 232 or optical fibre link.

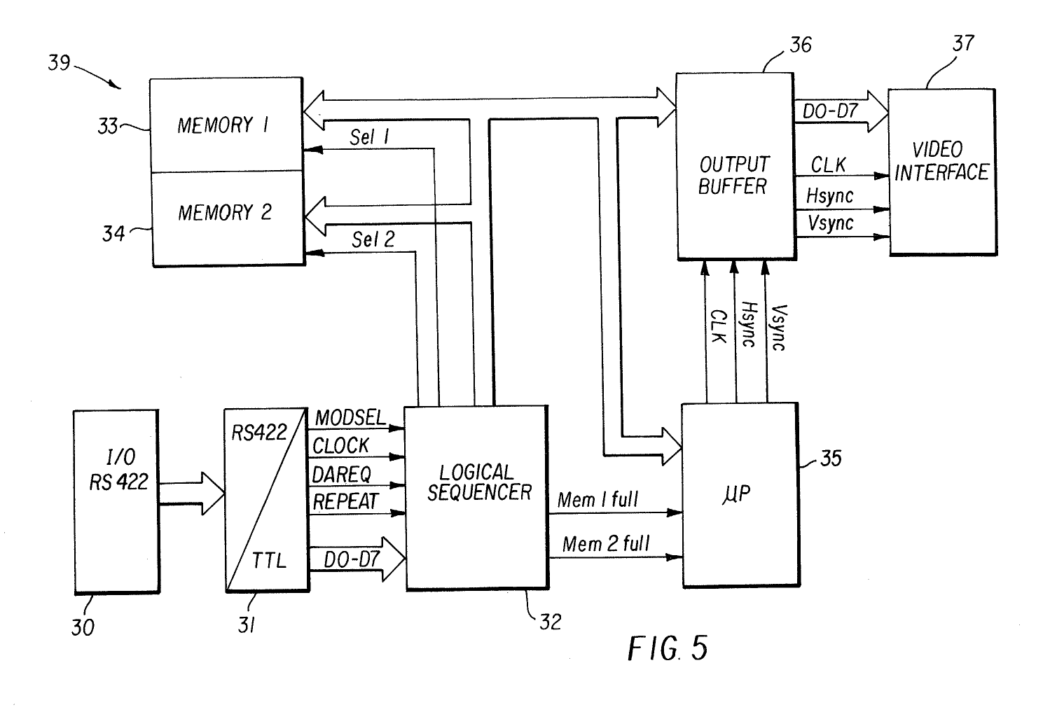

According to the present invention, the signals passing over the link 20 enter a digital interface card 39 forming the gateway system mentioned above. An embodiment of such an interface card 39 is illustrated in FIG. 5.

The digital interface card 39 includes connection means intended to take off the data passing over the RS 422/485 link without affecting the transfer thereof to the second station.

According to a particular embodiment, a 37-pin connector is used, the pin configuration of which is as follows:

| | |
|---|---|
| 1 | not used |
| 2 | not used |
| 3 | REPEAT |
| 4 | DAREQ |
| 5 | MODSEL |
| 6 | CLOCK |
| 7 | PARITY |
| 8 | DATA 7 |
| 9 | DATA 6 |
| 10 | DATA 5 |
| 11 | DATA 4 |
| 12 | DATA 3 |
| 13 | DATA 2 |
| 14 | DATA 1 |
| 15 | DATA 0 |
| 16 | not used |
| 17 | not used |
| 18 | not used |
| 19 | not used |
| 20 | not used |
| 21 | not used |
| 22 | REPEAT |
| 23 | DAREQ |
| 24 | MODSEL |
| 25 | CLOCK |
| 26 | PARITY |
| 27 | DATA 7 |
| 28 | DATA 6 |
| 29 | DATA 5 |
| 30 | DATA 4 |
| 31 | DATA 3 |
| 32 | DATA 2 |
| 33 | DATA 1 |
| 34 | DATA 0 |
| 35 | not used |
| 36 | not used |
| 37 | not used |

The signals used are differential signals. DATA 0-DATA 7 represent the image data bits, DATA 0 being the least significant bit and DATA 7 being the most significant bit. PARITY is a parity bit relating to the DATA 0-DATA 7 data. The MODSEL bit is a bit used to indicate the transmission mode. A 0 value of this bit indicates that the data transmitted are images; a 1 value indicates that the data are characters. CLOCK is a synchronous clock bit. All these signals are signals originating from the digital imaging equipment. The card also receives control signals coming from the laser reprographic unit. Thus the DAREQ bit instructs the imaging equipment to begin the transfer of a data packet. The REPEAT bit indicates to the imaging equipment that the last message transmitted was erroneous and that it should be sent again.

The data sent by the imaging equipment over the line 20 are in the form of packets which may be of three different types. The structure of these packets is as follows:

| Packet | | | | Last | |
|---|---|---|---|---|---|
| relating to the image size | | Packets of image data | | image data packet | |
| Word | Value | Word | Value | Word | Value |
| 1 | FF | 1 | FF | 1 | FF |
| 2 | 02 | 2 | 03 | 2 | 03 |
| 3 | No. Pix/ln. | 3 | Pixel 1 | 3 | Pixel 1 |
| 4 | No. Pix/ln. | 4 | Pixel 2 | 4 | Pixel 2 |
| 5 | No. ln./Imge | 5 | Pixel 3 | 5 | Pixel 3 |
| 6 | No. ln./imge | : | : | : | : |
| 7 | 00 | : | : | : | : |
| | | n + 2 | Pixel n | n + 2 | Pixel n |
| | | n + 3 | 00 | n + 3 | 01 |

As is clear from the above table, there are three types of packet: a first packet containing parameters relating to the image which is to be transmitted, and notably the number of pixels per image line (words 3 and 4) and the number of lines in the image (words 5 and 6); a plurality of packets containing the image data; and a last packet, in which the last word differs from the last word of the other image packets (01 HEX instead of 00 HEX), indicating that the image has been fully transmitted.

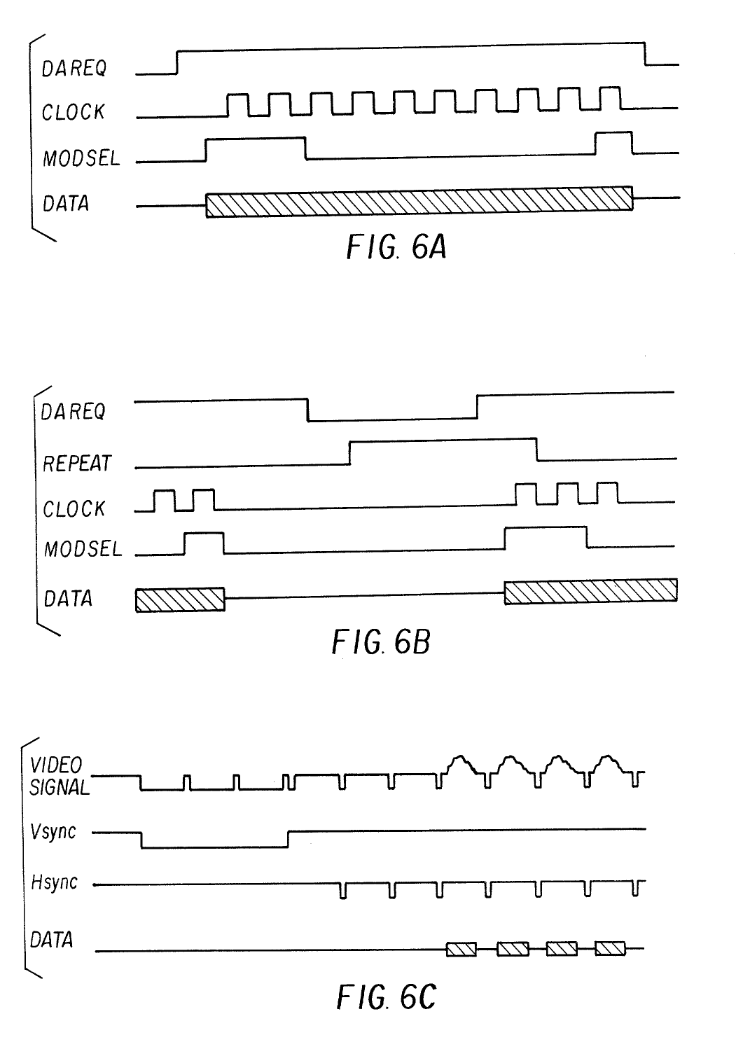

According to this embodiment, the communication protocol is as follows: in order to commence the image acquisition, and in response to a signal sent over the line 21, the laser reprographic unit sends a control signal DAREQ to the imaging equipment. When the DAREQ signal goes to the high level, the imaging equipment transmits the first packet relating to the size of the image transmitted. In response to the following DAREQ signals, the imaging equipment transmits the packets containing the image data. Typically, the image is transmitted in the order going from the pixel on the extreme left to the pixel on the extreme right, beginning with the first line of the image and ending with the last. The transmission continues until the end-of-image character 01 HEX has been identified by the laser reprographic unit. The shape of the signals mentioned above is depicted diagrammatically in FIG. 6A.

If an error is detected within a packet, the reprographic unit awaits the end of transmission of the current packet and requires the packet to be retransmitted by generating another DAREQ and by causing the REPEAT signal to go to a high level. The errors which are detected are typically errors relating to parity, the number of pixels per line or the number of lines per column, or errors relating to the start- or end-of- transmission signals. The control signals illustrating the error management procedure are depicted diagrammatically in FIG. 6B.

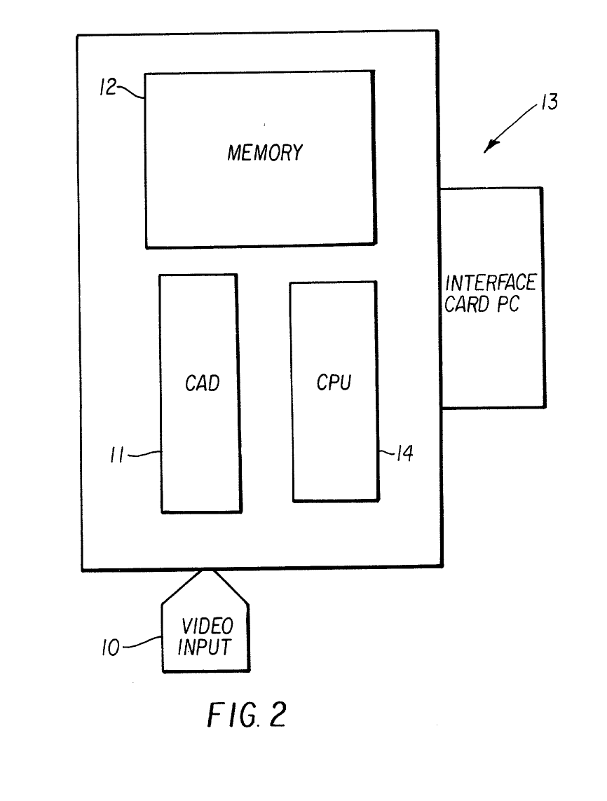

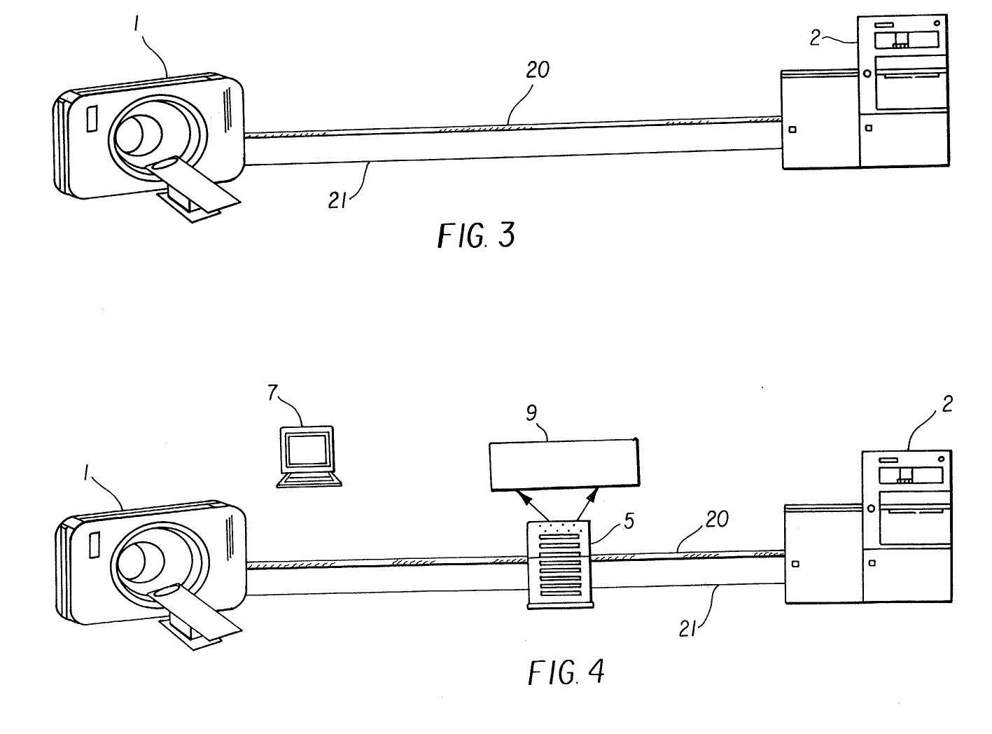

FIG. 5 depicts in block diagram form an embodiment of the communication interface 39 according to the invention This comprises a connector 30 receiving the differential signals mentioned previously. The differential signals received at the connector 30 are converted into TTL signals by means of a conversion circuit 31 and are then routed to a logic sequencer 32, which decodes the first data package in order to obtain the size of the image and loads the counter of one or other of the memories 33, 34 with the values of the number of lines per image and the number of pixels per line. The sequencer also has the function of alternately selecting one or other of the memories by virtue of the signals SEL 1 and SEL 2. In addition, if a REPEAT signal (generated by the laser reprographic unit) is detected, the sequencer prevents the memory counter from being incremented, so that the following packet overwrites the last packet in which an error was detected. Finally, the sequencer 32 indicates to the central unit 35 when one or other of the memories is full (Signals Mem 1 Full and Mem 2 Full). According to one advantageous embodiment, the memories 33 and 34 are used in alternation to store an image. By way of example, a memory block 33 can store one image whilst the other unloads the previous image to the output buffer memory 36. This solution makes it possible to avoid slowing down communication between the imaging equipment and the reprographic unit. According to an alternative, a single memory is used whilst holding up the DAREQ signal in order to slow down the transmission. The memory or memories are then unloaded into an output buffer memory 36, which also receives, from the central unit 35, a clock signal and synchronisation signals HSYNC and VSYNC, which are necessary to the video interface 37 to which are sent the signals stored in the memory 36. The video interface 37 is like the one described with reference to FIG. 2 and consequently does not require any additional description. The central unit 35 uses the data from the logic sequencer 32 to control the transfer between the appropriate memory block (33 or 34) and the output memory. FIG. 6C depicts diagrammatically the shape of the signals transmitted to the video interface 37. Unlike the utilisation described with reference to FIG. 2, and according to which a video signal (VIDEO SIGNAL) was sent over the video input 10, the data (DATA) are sent directly into the buffer memory 12, no video/digital conversion being necessary.

As was clear from the above description, the digital communication interface 39 uses the error control signals produced by the laser reprographic unit in order to manage the communication between the scanograph and, for example, a PC type computer (third station 9) via the digital video card 37. The data are then stored in memory blocks of the third station (9) and can then be manipulated in various ways and/or be sent over a network of the ETHERNET or NUMERIS type. In other words, like an oscilloscope, the digital communication interface takes off the data passing over the link between the scanograph and the reprographic unit without disturbing the transfer thereof. The laser reprographic unit commands are used to initiate communication from the scanograph to the digital interface card. Should the user not wish to obtain a printout of the image on the reprographic unit, the laser printer includes means for erasing its data files in order to prevent printing thereof. On the other hand, the communication interface card can be activated selectively (terminal 7) so as to be able to transfer the images only to the reprographic unit.

The approach which has just been described considerably facilitates the interfacing work required when digital communications are being dealt with, whatever the protocol and software versions used.

In the embodiments which have just been described, the first station (a scanograph or other digital imaging equipment) generates and stores the data to be transmitted. It is clear that the generation of the data can be effected at a workstation different from the first station.

What is claimed is:

1. Digital data communication system comprising:
a) a first station (1) including means for storing data in digital form;
b) a second station (2) intended to receive said data;
c) a bidirectional link (20) allowing transfer of said data from said first station to the second, said bidirectional link providing, in one direction, the transfer of the data and of parameters relating to the data transferred and, in the other direction, the transfer of command and control signals generated by the second station and intended to manage the transfer of said data;
d) a third station (9) intended to receive also said data, and;
e) a communication interface (39) having means (30-37) intended to capture the data passing over the bidirectional link (20) without affecting the transfer thereof to the second station (2) and to route them to the third station, and means (32) for managing, in response to the command and control signals generated by said second station (2), the transfer of the data to the third station (9).

2. Communication system according to claim 1, in which said first station (1) also comprises means for generating said data.

3. Communication system according to claim 2, in which the first station (1) includes medical imaging equipment, said data consisting, at least partly, of signals representing an image.

4. Communication system according to claim 3, in which the medical imaging equipment (1) is a scanograph, a magnetic resonance imaging device, a digital angiograph, a digital radiology table or an echograph.

5. Communication system according to claim 3 or 4, in which the second station (2) consists of a laser reprographic unit.

6. Communication system according to any one of claims 1 to 5, in which the communication interface (39) can be activated selectively.

7. System according to any one of claims 1 to 6, in which said first station (1) comprises means for generating a control signal to be sent to the second station, a signal in response to which the second station (2) generates for the first station a data request signal (DAREQ).

8. System according to claim 7, in which the means for generating the control signal include a keyboard.

9. System according to claim 7, in which the means for generating the control signal include a monitor on which an operator selects a printing command by means of a menu.

10. System according to any one of claims 1 to 9, in which said bidirectional link (20) consists of an RS 422/485 link.

11. System according to any one of claims 3 to 10, in which the first station also comprises means for displaying said image.

12. Communication interface (39) comprising:
a) means (30) intended to capture the data passing over a bidirectional link (20) between a first station (1) and a second station (2), said bidirectional link providing, in one direction, the transfer of the data and of parameters relating to the data transferred and, in the other direction, the transfer of command and control signals generated by the second station (2) and intended to manage the transfer of said data;
b) means (31-37) for routing the data thus captured to a third station (39) intended also to receive said data; and
c) means (32) for managing, in response to the command and control signals generated by the second station, the transfer of said data to said third station (9).

13. Communication interface according to claim 12, in which the data consist, at least partly, of signals representing an image.

14. Communication interface (39) according to claim 13, comprising:
i) connection means (30) for receiving the image data and certain control data passing over the bidirectional link (20);
ii) means (32) for decoding the data thus received, said decoding means being sensitive to said control data (DAREQ, REPEAT, MODSEL), so as to control the storage of the image data in appropriate storage means (33, 34); and
iii) means (35) for selectively controlling, in response to a signal transmitted by the decoding means (32), the unloading of the image data from the storage means (33, 34) to said third station (9).

15. Communication interface according to claim 14, characterised in that the data are unloaded to the third station (9) by means of a digital video card (37).

16. Communication interface according to claim 14, in which the storage means comprise two memory blocks (33, 34), addressable selectively by means of selection signals (Sel 1, Sel 2) generated by the decoding means (32), the decoding means (32) also generating signals (Mem 1 Full; Mem 2 Full) intended for the control means (35) for controlling the unloading of the data from one or other of the memory blocks (33, 34) to the third station (9).

17. Method for communicating digital information, comprising the following steps:
a) storing data in digital form in the memory of a first station (1);
b) transferring said data from said first station (1) to a second station (2) by means of a bidirectional link (20), said bidirectional link providing, in one direction, the transfer of the data and of parameters relating to the data transferred and, in the other direction, the transfer of command and control signals generated by the second station (2) and intended to manage the transfer of said data;
c) capturing the data passing over the bidirectional link (20) without affecting the transfer thereof to second station (2), and
d) routing the information thus captured to a third station (9), the transfer of the data to said third station (9) being managed by the command and control signals generated by said second station (2).
